(19) United States
(12) Patent Application Publication
(10) Pub. No.: US 2009/0022282 A1
(43) Pub. Date: Jan. 22, 2009

(54) Data Transmission Method and System for Forming a Global Emergency Call/Warning System Especially Using a Satellite Navigation System Such as Galileo

(75) Inventors: Alexander Steingass, Gilching (DE); Hermann Bischl, Aldersbach (DE); Sandro Scalise, Munchen (DE)

Correspondence Address: THE H.T. THAN LAW GROUP, WATERFRONT CENTER SUITE 560, 1010 WISCONSIN AVENUE NW, WASHINGTON, DC, 20007, US

(73) Assignee: DEUTSCHES ZENTRUM FÜR LUFT- URAUMFAHRT E.V., Koeln (DE)

(21) Appl. No.: 11/816,222

(22) PCT Filed: Feb. 17, 2006
(86) PCT No.: PCT/EP06/01471

§ 371 Date: Jun. 6, 2008

(30) Foreign Application Priority Data
Feb. 18, 2005 (DE) 10 2005 007 465.0
Feb. 18, 2005 (DE) 10 2005 007 466.9
Feb. 18, 2005 (DE) 10 2005 007 548.7
Feb. 18, 2005 (DE) 10 2005 007 549.5
Feb. 18, 2005 (DE) 10 2005 007 550.9

(51) Int. Cl. H04M 11/04

(52) U.S. Cl. 379/45

(57) ABSTRACT

Disclosed is a communication system (1) for advantageous use in a global emergency call/warning system, comprising at least one communication device (20, 21, 22) and a central device (10) that is connected to said communication device (20, 21, 22) in order to exchange text data. The connection between the communication device (20, 21, 22) and the central device (10) is established via at least one satellite (30). Data transmitted by the communication device (20, 21, 22) contains additional information about the current position of the communication device (20, 21, 22), or data transmitted by the central device (10) contains additional information about the local relevance of the text data.

The present invention relates to a communication system which is preferably intended for use in a global emergency call/warning system and has for this purpose at least one communication device and a central facility connected to the communication device for exchanging text information, the connection between the communication device and the central facility being made via a satellite—preferably the satellite of a navigation system. In addition, the present invention relates to a method for satellite-based information transmission for forming a global emergency call/warning system.

In recent years, the transmission of text information as part of the Short Message Service (SMS) has increasingly gained in importance as part of general communication. What was only thought of as a simple additional option for mobile radio telephones a few years ago has developed into a significant source of income for the operators of mobile radio networks in the meantime. The reason for this is that SMS messages can be used for transmitting the most varied information items in a simple manner.

The many possible ways of using SMS messages have also led to considerations of using this type of information transmission in the areas of emergency calls or of warning various persons about hazards. Since mobile radio telephones are widely used, it would definitely be worth considering requesting aid by means of an SMS message in the case of an accident or the like. On the other hand, SMS messages can also be used for warning a multiplicity of persons about impending hazards. In this connection, it has been found that systems previously existing for warning about impending catastrophes of nature or other hazards are still inadequate since they do not guarantee with sufficient reliability a reliable and timely transmission of warning information to a large proportion of the population affected.

The requirements for an emergency call/warning system are thus extremely high since the targets aimed for, namely a fast and reliable request for aid or, respectively, a comprehensive warning of persons or regions affected can only be achieved in the case of an absolutely reliable data transmission. As a rule, previously existing communication systems do not provide such a high operational reliability since a general communication link between a single device and a central facility of the emergency call/warning system is not guaranteed in principle. Thus, it is not ensured that an emergency call can be delivered at every time and at every location. It is true that other systems offer a communication link for transmitting data that is available at any time, but they require the use of very special and correspondingly expensive terminals. Accordingly, these systems, too, cannot be used for forming an emergency call/warning system that is global and thus can be used by the largest possible number of persons.

Accordingly, the present invention is firstly based on the object of specifying a possibility of transmitting text information in a simple and reliable manner between a communication device and a central facility connected to the communication device, in order to create by this means the prerequisites for forming a global emergency call/warning system.

The object is achieved by the invention specified in the independent claims. Advantageous developments of the invention are the subject matter of the subclaims.

According to a first aspect of the present invention, a communication system preferably to be used in a global emergency call/warning system is correspondingly proposed which has at least one communication device and one central facility connected to the communication device for exchanging text information, wherein the connection between the communication device and the central facility is made via at least one satellite and data transmitted by the communication device contain additional information about the current position of the communication device or data transmitted by the central facility contain additional information about the local relevance of the text information.

The core concept of the present invention is thus to carry out the information exchange between the various components of the communication system via a satellite link and to add to the transmitted data additional information about the current position of the communication device in the case of the transmission from the communication devices to the central facility or additional information about the local relevance of the information in the case of the transmission of information from the central facility to the communication devices. Using a satellite link has the advantage that a communication link can be set up at almost any location on earth. It is thus ensured that aid can be requested at any time, for example in the case of an accident. On the other hand, naturally, a satellite can be used for addressing a multiplicity of communication devices at the same time so that in the case of a warning message, it is possible to contact a large proportion of the persons affected. However, purely transmitting a warning information item naturally does not make sense since the receiver of the information must have also have the possibility of finding out whether he is affected by the possibly impending hazard or not. Furthermore, simply requesting aid for an accident victim does not by itself lead to results if it is not certain where the person needing aid is located. The additional transmission of information about the current position of the communication device or, respectively, of information about the local relevance of the information, supplementing the satellite link provided, now ensure that the aid needed can also actually be requested in suitable manner or, respectively, the persons who are actually affected by an impending hazard can be warned. The communication system according to the invention thus meets precisely those requirements which are set for a globally useable emergency call/warning system. Apart from the location information, the communication device preferably also transmits information with regard to its current movement (course and speed) so that finding the person looking for aid is facilitated at a later time.

Further developments of the present invention relate to, among other things, special technical measures by means of which the data exchange between the various participants in the communication system according to the invention is optimized.

As has already been mentioned, the terminals for communication, used by a consumer, should be constructed in such a manner that they can be produced inexpensively and accordingly can be used by a multiplicity of persons. In particular, it should be avoided to have to use specially equipped terminals with high transmission power. Instead, the use of devices largely based on devices already in use today in general mobile radio technology is desirable. The transmission powers of such devices are usually within the range of a few watts.

However, in order still to provide for reliable data communication at such comparatively low transmission powers, special measures must be taken to guarantee that the information is transmitted from the communication device to a satellite. Accordingly, a first advantageous development of the present invention deals with measures which guarantee the safe and reliable transmission of information from a communication device to the satellite. In this context, it must also be taken into consideration that in providing such a system globally, a number of terminals may wish to deliver emergency calls at the same time, as a rule, which leads to further complications with the low transmission powers aimed for. In accordance with the advantageous development of the present invention, a special method for transmitting text information is correspondingly provided wherein, as part of an initialization procedure, data regarding a predetermined reception time for the information to be transmitted and/or a predetermined reception frequency are first transmitted to the communication device and wherein the communication device then determines a suitable time for transmitting the information and/or a suitable transmission frequency on the basis of supplementary information with regard to the positions and/or movements of the communication device and of the satellite.

It is also provided that the data are transmitted from the communication device to the satellite in such a manner that they arrive there within a previously determined period of time and thus without collisions and with a specially predetermined reception frequency. This distinctly increases the capacity of the system with regard to the number of items of text information which can be successfully transmitted, since the number of signal collisions is reduced. Avoiding collisions also has the result that signals with relatively low transmission powers can still be received reliably and free of errors, since undisturbed, at the satellite. As part of the initialization procedure, it is preferably provided that the communication device transmits a first inquiry to the satellite and, in response to this inquiry, information with regard to a reception time assigned to it and/or a predetermined reception frequency is transmitted to the communication device.

Incidentally, this concept of a special method for setting up a data link in which information with regard to a suitable reception time for the information to be transmitted and/or a suitable reception frequency is first transmitted to the communication device as part of an initialization procedure, wherein the communication device then determines a suitable time for transmitting the information and/or a suitable transmission frequency on the basis of supplementary information which relates to the positions and/or movements of the communication device and/or of the satellite can also be used independently of the type of information transmitted. In general, this method has advantages in satellite-based communication systems.

According to a second aspect of the present invention, a communication system with a communication device and a facility, formed by a satellite, for receiving information to be transmitted by the communication device is correspondingly proposed wherein data with regard to a predetermined reception time for the information at the satellite and/or a predetermined reception frequency is transmitted to the communication device as part of an initialization procedure and wherein the communication device then determines a suitable time for the transmission of the information and/or a suitable transmission frequency on the basis of supplementary information with regard to the positions and/or movements of the communication device and of the satellite.

This adaptation of the transmission frequency of the communication device is already required inasmuch as a Doppler shift of the signal can occur due to the relative movement between the communication device and the satellite, this Doppler shift in turn being compensated for by a suitable adaptation of the transmission frequency. On the other hand, however, it can also be provided, for increasing the data traffic, that the satellite provides a number of frequency bands on which it can receive data simultaneously. In this case, the different frequency bands or subcarriers should be utilized as uniformly as possible in order to ensure parallel transmission of emergency call information. In this case, too, the transmission frequency of the communication device must then be correspondingly adapted in a suitable manner to the subcarrier assigned to it. Adapting the transmitting time, in turn, takes into consideration the propagation time of the signal and ensures that the information will actually arrive at the satellite within the predetermined period of time and thus without overlapping other signals.

In this special method for setting up the data link, information is not only transmitted from the communication device to the satellite but also in the opposite direction. On the one hand, the required information with regard to the reception frequency and the reception time must be transmitted from the satellite to the communication device and, on the other hand, an acknowledgement of the reception of the emergency call information by a central control station of the emergency call system is desirable.

Naturally, an adaptation of the transmission frequency and of the transmitting time by the satellite as is provided for the transmission of information from the communication device towards the satellite is not possible for the transmission of information from the satellite to the receiver. Although the signal transmitted from the satellite to the communication device has a higher power, additional measures should be provided which provide for an optimum and reliable reception of the satellite signals.

According to another advantageous development of the present method, it is correspondingly provided that the communication device receives, separately from the data actually to be received, supplementary information on the basis of which the device matches its behavior to the reception of the satellite signals. In the context of this advantageous development of the invention, the receiving characteristic of the communication device is thus optimized with the aid of an auxiliary system in order to ensure reliable data reception. This supplementary information can be, in particular, the navigation information with regard to the positions and/or movements of the communication device and/or of the satellite. Using this supplementary information, the communication device can then better estimate the frequency of the incoming satellite signal, for example, and match its receiving characteristic thereto. This also ensures improved estimation of the phase of the satellite signal, which is indispensable for reliable reception.

This concept, according to which a communication system with a central transmitting device—particularly a satellite—for transmitting data signals and a communication device for receiving these data signals is proposed, wherein the communication device matches its behavior for receiving the data signals on the basis of supplementary information which is transmitted to the communication device separately from the data signals, can in turn also be used independently of the concept of the invention previously described. In this context, a communication device for use in a corresponding communication system is also proposed wherein the communication device firstly has receiving means for receiving the data signals which are transmitted by a central transmitting device. Furthermore, means for receiving supplementary information are provided which contain information with regard to certain characteristics of the data signals to be received, wherein the receiving means of the communication device match their receiving characteristic on the basis of the supplementary information. Furthermore, a method for transmitting and receiving data signals is also proposed wherein a communication device provided for receiving the signals matches its behavior for receiving the data signals on the basis of supplementary information which is transmitted separately from the data signals.

This information provided in supplementary manner—for example in a separate frequency band—can be, in particular, information with regard to the positions and/or movements of the communication device and/or of the transmitting device. For example, it can also be provided that the communication device additionally has a navigation receiver or, respectively, a navigation receiver is allocated to the communication device, with the aid of which navigation data is received via the device itself and via the satellite or, respectively, the transmitting device. On the basis of this information, the communication device can then better estimate, for example, the frequency of the incoming data signal since the Doppler effect occurring due to the relative movement between the satellite and the device can be taken into consideration. This also ensures an improved estimation of the phase of the data signal which is indispensable for a reliable reception of the signal.

A particularly advantageous embodiment of this method consists in that the supplementary information for optimizing the reception of the data signals is transmitted by the same transmitting device but at a different frequency independently of the data signals. In this case, for example, a satellite of a navigation system is also used simultaneously as transmitting device for the communication system in order to provide both the data signals and the navigation information. This provides for an optimized data reception by the communication device in a particularly simple and effective manner. The measures for extending the range of functions of the navigation satellite according to this advantageous development are kept within limits, so that in this way it is possible to create in a particularly simple and effective manner the foundations for an emergency call/warning system which is actually available globally and operates reliably.

A further advantageous development of the invention in turn relates to measures for transmitting warning information from the satellite to the communication device or devices. Since such warning information should be transmitted as comprehensively as possible to persons affected, it should also be ensured that devices located within closed buildings can receive the information. As a rule, however, the transmission powers of satellites normally used for this purpose are not sufficient for receiving signals within closed buildings. The reason for this is, as a rule, that the signals reach the receiver predominantly via reflections from objects located in the environment and, accordingly, the signals finally arriving are too weak for unambiguous evaluation.

To bypass this problem, it is provided in accordance with a further advantageous development of the invention that the data transmitted by the satellite to the communication device or devices contain an information component containing the text information—that is to say, for example, the warning message—and a coordination component which is used by the communication device for synchronizing to the satellite. The data containing the text information are then transmitted at least twice by the satellite, wherein the communication device adds the information components received during the multiple transmissions in the correct phase and determines text information from the aggregate signal formed during this process. By transmitting the information several times and adding the information components in the correct phase, which is made possible with the aid of the coordination component, an aggregate signal can finally be formed which is strong enough for an unambiguous and error-free evaluation of the information. This also enables information to be received within closed buildings. This does not even require the data transmission to be regular or repeated periodically since the coordination component can also be utilized for unambiguously identifying the—preferably following—text information. This distinctly increases the possible uses within the context of a global warning system since very simple devices can also be used as receivers which do not necessarily need to be connected to a receiving device outside of buildings.

This idea of transmitting information several times via the satellite and by ensuring by means of suitable measures that, due to the multiple reception of the signals, the communication device is lastly capable of performing a more reliable data evaluation in comparison with a single reception can also be utilized independently of the type of transmitted information. According to this aspect, a system preferably for use in a global warning system for transmitting messages from a central transmitting device via a satellite to at least one communication device is thus proposed wherein data transmitted by the satellite contain an information component containing the messages and a coordination component which is used by the communication device for synchronizing to the satellite and wherein it is provided that the data containing the data are transmitted at least twice by the satellite and the communication device adds together the information components received during the multiple transmissions in the correct phase and transmits the messages from the aggregate signal formed during this process. Furthermore, a communication device for receiving satellite signals—preferably for use in a global warning system—is proposed which has receiving means for receiving data which contain an information component containing messages and a coordination component, wherein the coordination component is used by the receiving means for synchronizing to a satellite transmitting the data, and wherein the receiving means are also equipped for adding together the information components, received during a multiple transmission of the data, in the correct phase and determining the messages from the aggregate signal formed during this process.

In the context of an advantageous development of the present method, it is not absolutely necessary that the information transmission be repeated periodically, as already indicated. Instead, it is quite possible to transmit different messages in the successive transmission periods, wherein the communication devices then in each case form aggregate signals of the information components corresponding to the respective message. This capability is achieved by the fact that the message contained in the information component is additionally unambiguously identified by the coordination component. In simplified terms, a number for the following message is specified in the coordination component so that the communication device is capable of correctly adding the corresponding information components in each case. Apart from the main task, namely providing for synchronization or, phase estimation of the satellite signal respectively, another task of the coordination component consists in informing the communication device about which message is currently being transmitted. This ensures that different messages can also be transmitted virtually simultaneously.

Incidentally, this method of adding information components in the correct phase can also be used independently of whether the signals are transmitted by a satellite or by any other transmitting device. However, depending on the type of transmitting device, superproportional weighting of the coordination component is advantageous. This ensures that in-phase adding together of the information components and thus finally an evaluation of the transmitted information is actually possible.

As already explained, the text information transmitted as warning information from the satellite to the communication device is provided, according to the invention, with additional information which provides information about the local relevance of the text information in order to enable receivers of the information to estimate the extent to which the warning information is relevant for them. As a supplement to this, there can also be a user-specific relevance, however. Thus, for example, the warning against the bursting of a dam is of no interest for an aircraft even if the aircraft is located above the region possibly endangered by the bursting dam.

According to a further advantageous development of the invention, it is correspondingly provided that the additional information also provides information about a user-specific relevance of the messages wherein, according to a particularly advantageous development, each communication device, by evaluating this additional information, first checks whether the messages are relevant for the respective communication device with regard to the location of the device and/or with regard to the user and processes or reproduces the messages in dependence on this check. The communication device must thus be provided with additional information about the current location and its use which can be done in a particularly simple manner, for example, via a manual input by the user of the communication device. However, other possibilities for determining location would also be conceivable, particularly the use of navigation signals or of cell identification numbers of a mobile radio network.

This idea of providing means by means of which the warning information can be prefiltered, as it were, so that the users of the communication devices are finally provided with or shown only that information which is also relevant to them with a high probability, can also be used independently of the concept of the invention previously described. According to another aspect, an information system for transmitting messages from a central transmitting device, particularly a satellite, to a multiplicity of communication devices is correspondingly proposed wherein data transmitted by the central transmitting device contain, apart from the actual message, additional information which provides information about a local and/or user-specific relevance of the messages and wherein each communication device initially checks, by evaluating the additional information, whether the messages are relevant for the respective communication device and processes or reproduces the messages in dependence on this check. This aspect also relates to a communication device for use in a corresponding information system which has receiving means for receiving data which contain messages and supplementary information which provides information on a local and/or user-specific relevance of the messages. The communication device also has evaluating means for checking, by means of the supplementary information, whether the messages are relevant to the communication device or not, and processing and reproducing means for processing or reproducing the messages in dependence on the result of the check by the evaluating means.

The information with regard to the local relevance of the information can define, for example, a geographic region for which the messages are relevant. This region can be defined, for example, by a number of locations which include the region, wherein these locations are specified, for example, by a reference position and a number of relative positions. The accuracy of the position information for the various positions can be made dependent on, among other things, the maximum size of the region affected, wherein it is usually provided that the reference position is specified with a higher accuracy than the relative positions. This makes it possible to reduce to a relatively small amount the quantity of data to be transmitted for specifying the region affected.

The communication system according to the invention preferably has a number of satellites which enable data to be exchanged in different frequency bands, wherein it is then provided that the communication device transmits data at the frequency of that satellite which guarantees the best possible transmission because of its current position. In this case, too, the use of information which informs about the current position of the various satellites is also of advantage. In a particularly advantageous manner, it can be correspondingly provided that the satellites of a navigation system (for example of the GPS system already existing or the Galileo system being planned) are at the same time also used for implementing the communication system according to the invention, that is to say, in addition to the transmitter for transmitting the navigation information, at the same time also have transmitting and receiving means for data transmission in the context of the communication system according to the invention. The required extensions for the navigation satellites are kept within limits so that an emergency call/warning system could be implemented in a particularly simple manner which is actually available globally and operates reliably.

The communication devices used can be of different construction and have different functions depending on the field of use. The use of very simple devices that only provided for receiving warning information would also be conceivable.

In the text which follows, the invention will be explained in greater detail with reference to the attached drawings, in which:

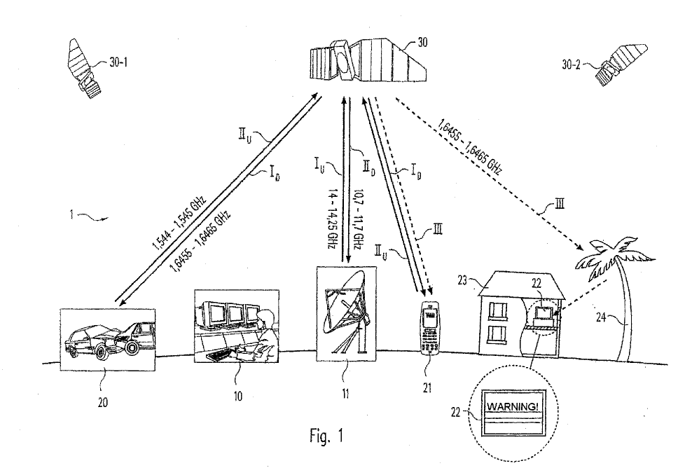

FIG. 1 diagrammatically shows the components of a communication system according to the invention;

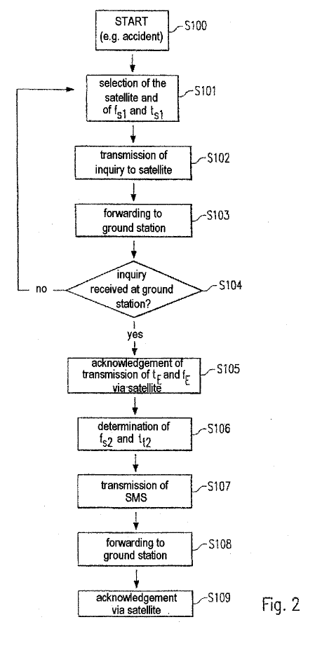

FIG. 2 shows the sequence of a method for transmitting an emergency call from a communication device;

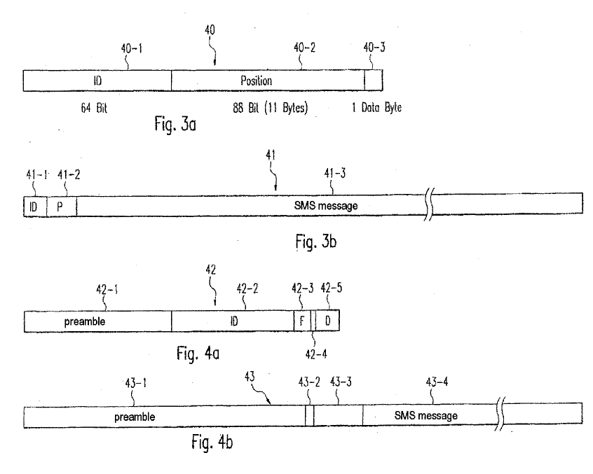

FIG. 3a shows a conceivable structure of a data packet for transmitting a request in the method according to FIG. 2;

FIG. 3b shows the structure of a text message transmitted by a communication device;

FIG. 4a shows the structure of a response message in the method according to FIG. 2;

FIG. 4b shows the structure of a global warning message;

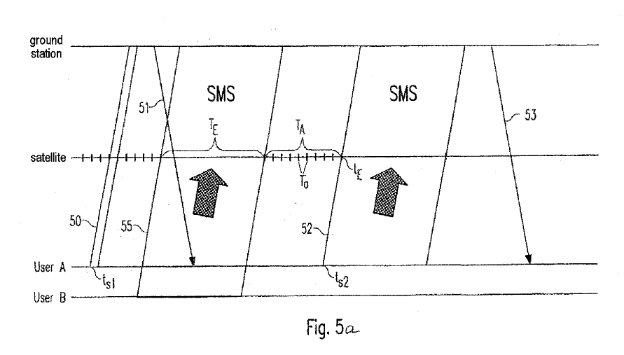

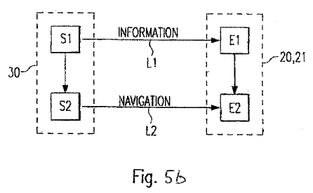

FIG. 5a shows a timing diagram for transmitting an emergency call;

FIG. 5b diagrammatically shows the structure of a system for optimized data reception;

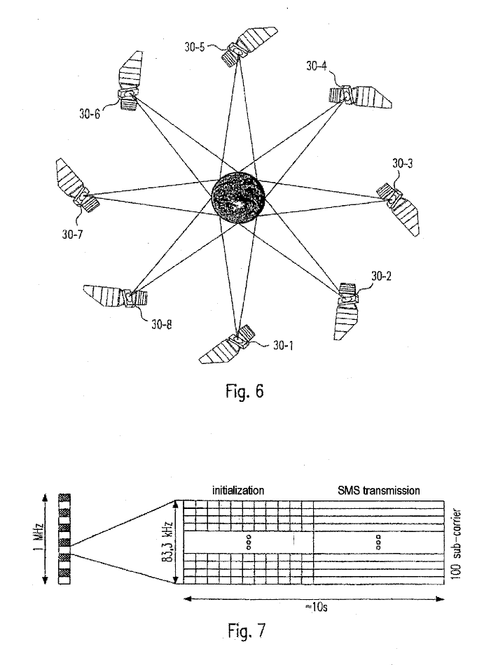

FIG. 6 shows a diagram for illustrating the frequencies which can be used by the satellite;

FIG. 7 shows the division of the frequency band used for the data transmission;

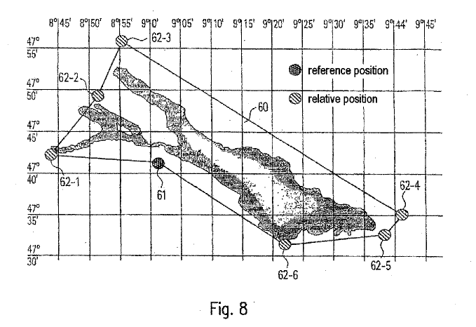

FIG. 8 shows the procedure for defining a region for which a transmitted warning message is relevant; and

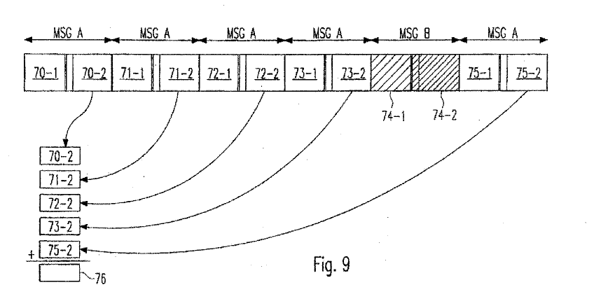

FIG. 9 shows a diagram for illustrating the procedure for receiving information within a closed building.

FIG. 1 initially shows diagrammatically the components of a communication system according to the invention which is generally provided with a reference symbol 1 and which, in particular, can be used for implementing a global emergency call/warning system.

According to the diagram, the central station of the emergency call/warning system 1 is formed by a central facility 10, for example a telephone control center which receives and evaluates incoming emergency calls from participants in a system and—if necessary, initiates suitable aid measures. In the case of an accident of a participant, for example, a rescue vehicle or a rescue helicopter can be informed and ordered to the accident location by the central station 10. The central station 10 has also the further task of acknowledging incoming emergency calls and transmitting corresponding replies. Finally, the central station 10 can also be used as control station for a warning system and can send information to the participants in the system 1 in the case of an impending hazard.

FIG. 1 shows diagrammatically three participants in the communication system according to the invention which can be of very different nature with regard to their embodiment and positioning. A first participant 20 is formed, for example, by a vehicle wherein the communication device arranged in the vehicle is constructed for requesting aid in the case of an accident and, for example, the triggering of an airbag. This can be initiated manually by the user of the vehicle but it would also be quite conceivable that the communication device sends an emergency call automatically when a serious accident occurs.

A second participant 21 is formed by a portable communication device which, in particular, can also be formed by a mobile telephone. Apart from the normal capabilities for mobile radio telephony, this telephone 21 correspondingly has extensions which enable an emergency call to be transmitted or a corresponding reply or a warning message to be received.

A third participant is formed, for example, by an electric device, for example a television device 22. A special feature of this third participant consists in that the television device 22 is arranged within a building 23 which has an effect on the possibilities for data communication which will still be explained in more detail later. In this case, the stationary device 22 can therefore be provided exclusively for receiving warning information by the system 1, but not for transmitting emergency calls.

It must be noted that the terminals of the system 1 according to the invention can be of many types of construction and can have the most varied functions. Within the system 1 according to the invention, they can also be used in different ways. Thus—as already explained—it can be provided that certain devices are exclusively suitable for receiving warning messages by the system 1 whereas other devices can both transmit emergency calls (possibly automatically under certain conditions) and can additionally also receive warning information. The information used additionally by the various participants 20, 21 and 22 in the context of the system can also be of different types, depending on the construction of the devices.

For the communication between the various participants 20, 21 and 22 and the central station 10, satellites 30, 31-1, 30-2 are used as connecting elements via which the data link is set up. The connection to the central station 10 is made possible with the aid of a transmitting/receiving station 11 which is connected to the central station 10. The arrangement of the satellites and their number is preferably selected in such a manner that a connection can be set up throughout the world between the participants 20, 21, 22 and one of the satellites 30, wherein in each case at least three satellites 30 should be preferably located within the transmitting and receiving range of a communication device 20, 21, 22 in order to provide for alternative connections in the case of the failure of one data connection.

The signals exchanged between the various components of the system 1 according to the invention can be distinguished in accordance with their use within the emergency call/warning system. As already mentioned, the delivery of an emergency call by the participants and the corresponding response to this emergency call by the central station 10 represents a first function of the system 1. Depending on the direction of the data transmitted and in accordance with the various components between which a communication link exists, the communication links produced during this process can be distinguished as follows.

Thus, two forward links are initially provided which are used for transmitting information from the central station 10 to the receivers 20 and 21. These forward links are also distinguished by the fact of whether they are directed towards the satellite 30 or lead away from it. Accordingly, information is transmitted from the central station 10 or the transmitting/receiving station 11, respectively, i.e. via a forward uplink I_{U} to the satellite 30 and via a forward downlink I_{D} from the satellite 30 to the communication devices 20, 21. The transmission of information from the terminals 20, 21 to the central station 10 takes place via reverse links, more precisely via a reverse uplink II_{U} from the devices 20, 21 to the satellite 30 and a reverse downlink II_{D} from the satellite 30 to the transmitting/receiving station 11 of the central station 10, on the other hand. The various procedures of transmitting data, particularly in the context of the reverse uplink II_{U} and the forward downlink I_{D}, will still be explained in detail later whereas the communication between the satellite 30 and the transmitting/receiving station 11 can take place in the context of normally used methods which are not the subject-matter of the present invention.

Further communication links which are set up as part of the emergency call/warning system according to the invention are used for transmitting warning information in accordance with the second function of system 1. In this case, only one communication is provided in the direction from the central station 10 to the terminals 21 and 22 and a forward uplink III_{U} (constructed in the usual manner) is thus again formed to the satellite 30 and a forward downlink III_{D} is formed from the satellite 30 to the terminals 21, 22. The special measures for forming the forward downlink III_{D} for transmitting warning information will also be explained in detail later.

In principle, the frequency bands used for setting up the various communication links can be selected as desired, taking into consideration regulatory stipulations. However, it has already been explained initially, the terminals should be largely based on technologies already being used. Accordingly, it has been found to be advantageous to use frequencies in the so called L band in the range between 1.6455 and 1.6465 GHz for the forward downlink and frequencies, again in the L band, in the range between 1.544 and 1.545 GHz for the reverse uplink. The advantage of this selection lies in the fact that these frequency ranges are close to the frequencies used by mobile radio networks already existing and, in addition, also include the frequency ranges used in navigation systems. Transmitting and receiving means for using such frequencies are thus already being widely used and can accordingly also be used in devices in the context of the system 1 according to the invention. For the forward uplink, frequencies in the Ku band between 14 and 14.25 GHz are preferably used and for the reverse downlink frequencies in the X band in the range between 10.7 and 11.7 GHz are used. The advantage of the choice of these frequencies lies in that the antennas used for this purpose can be made geometrically small. It should be pointed out again, however, that other frequencies could also be used for the various signal paths.

In the text which follows, the exchange of data between an end user 20, 21 and the satellite 30 will be discussed first in the context of an emergency call. In this case, the user of the device should be capable of requesting aid by means of an SMS or text message. The central station 10 should also be able to establish where precisely the user of the device is located.

In this case, the transmission of the information from the devices 20, 21 to the satellite 30 is particularly critical which is attributable to the low transmission power of the devices 20, 21, on the one hand, and the high data traffic, on the other hand. The first thing to be taken into consideration in this connection is the frequency with which an emergency call can be expected. Statistical research has shown that the main cause for initiating emergency calls will be traffic accidents. In Germany, for example, the number of traffic accidents exceeds the number of conceivable other events by far. If it is assumed that the statistical frequency for the occurrence of a traffic accident is approximately the same in Europe—which approximately corresponds to the coverage area of a satellite, an approximate frequency of 0.36 emergency calls/s is obtained for a single satellite. Since the transmission of an emergency call message takes a number of seconds, there is the risk, therefore, that a number of end users will attempt at the same time to transmit an emergency call to the satellite. As a result of the low transmission powers of the devices, the overlap of these signals will in the end lead to the satellite no longer being able to separate and unambiguously identify the information. The transmission of both emergency calls would thus fail in this case.

To avoid such conflict situations, a special reservation method, which will be explained in greater detail by means of the flow chart of FIG. 2 in the text which follows is proposed for transmitting an emergency call from an end user and the response to this emergency call by the central station 10 of the system 1.

The basic idea of the reservation method shown diagrammatically in FIG. 2 is that the communication device which wishes to transmit an emergency call first transmits a short message to the satellite or the central station, respectively, as part of an initialization procedure, and announces the transmission of an emergency call or generally of a message. A corresponding transmission period is then reserved for the device in which only the corresponding device is authorized for transmitting a message. The device then ensures, by means of measures still explained in greater detail later, that the message arrives at the correct time and with the correct frequency at the satellite so that reliable reception is made possible even at low transmission powers.

The prerequisites for this special procedure are that the terminal additionally has a navigation receiver which is also in contact with the satellite. The device thus knows its own position, speed and direction of movement, on the one hand, and the position of the satellite, its speed and its direction of movement, on the other hand. In addition, the information received as additional assistance by the navigation receiver can be used for synchronizing the device to the satellite almost perfectly with regard to time and frequency so that deviations only in the nanosecond range occur, if any. This information can correspondingly be used for transmitting information to the satellite at the correct frequency and in the correct time. The method shown in FIG. 2 correspondingly appears as follows.

After the occurrence of an emergency in step S100, the device first selects, on the basis of the information with regard to the positions and movements of the communication device and of the satellites provided by the navigation receiver, a suitable satellite which guarantees the best possible data transmission by reason of its current position. Thus, the satellite is selected with which the best receiving performance with regard to the signals to be transmitted can be expected is selected. In addition, the device knows the frequency on which the selected satellite can receive information. Correspondingly, a first transmission frequency fₛ₁ is selected via the transmitting means of the communication device, which frequency is determined by taking into consideration the relative movement between satellite and communication device, in order to compensate for the frequency shift due to the Doppler effect occurring during the transmission to the satellite. This thus ensures that the signal arrives at the satellite exactly with the reception frequency “preferred” by it. As will still be explained in greater detail later, the satellite preferably uses a number of reception frequencies in parallel, one of these frequencies then being selected at random and the first transmission frequency fₛ₁ being determined on the basis of this randomly selected reception frequency and of the navigation information.

Furthermore, it is provided in the context of the method according to the invention that the satellite can receive signals by means of which the transmission of text information is announced only within certain time intervals. In the context of this so-called slotted-Aloha method, it is thus provided that such inquiries only arrive at the satellite within certain time intervals. Although the problem still exists that when two inquiries arrive simultaneously, none of the signals can be evaluated by the satellite, the probability of a data collision is clearly reduced in such a method in which the periods for inquiries are predetermined. In step S101, therefore, a starting time tₛ₁, at which the inquiry is sent from the device, is also selected on the basis of the navigation information. This time, too, will be selected in accordance with the principle of randomness, but with the aforementioned restriction that the signal lastly arrives at the satellite at a “permissible” time.

It should be noted that, instead of predetermined periods within which an inquiry is in each case accepted at the satellite, a greater period could also be provided for transmitting such inquiries. However, the probability of a data collision would be slightly higher in this case.

After the selection of the transmission frequency fₛ₁ and the transmitting time tₛ₁, an inquiry is then transmitted to the satellite in the subsequent step S102, in which—as already mentioned—the transmission of a relatively long text message is announced or requested.

A possible format for such an inquiry is shown in FIG. 3a which shows that the data packet consists of a total of three areas. A first area 40-1 of the complete data packet 40 is used for transmitting an identification number (ID) of the communication device via which it can be unambiguously identified. According to the embodiment shown, this area has a length of 64 bits. The second block 40-2 is used for already transmitting the position of the device and its current movement. This block has a length of 88 bits which are composed as follows:

$$\begin{matrix}Width & 25 bits ⇒ 1.2 m resolution \\ Length & 25 bits ⇒ 1.2 m resolution \\ Height & 14 bits ⇒ 1.2 m resolution from 0 \text{-} 20 \; 000 m \\ Speed & 12 bits ⇒ 0.24 m \text{/} s resolution up to 1000 m \text{/} s \\ Direction of course & 12 bits ⇒ 0.09 ° resolution \\ Total & 88 bits\end{matrix}$$

A third block 40-3 is used for announcing information about the type of emergency call already in the context of a short message. For example, this could be used for coding the severity of the emergency and the type of aid needed. This results in a total length of 160 bits for this inquiry data packet 40.

It must be noted that the structure and length of this first data packet 40 can also be selected to be different. It is essential, however, that this data packet used for the inquiry to the satellite is distinctly shorter than the actual message which will be transmitted at a later time. It also requires the use of a data block for identifying the communication device.

In accordance with the representation in FIG. 2, the signal sent as part of the inquiry is then forwarded from the satellite to the ground station in step S103, wherein the ground station checks in the subsequent step S104 whether the inquiry has arrived singularly at the satellite and the forwarded signal can accordingly be unambiguously evaluated by the ground station or if an overlap with other signals—for example inquiries from other participants in the communication system—possibly took place. The satellite itself is thus transparent, i.e. it forwards the signals in both directions without analyzing or evaluating them in greater detail. The satellite only performs a conversion into the various frequency bands for the uplinks and downlinks.

If it was possible to receive a single inquiry at the ground station or the central station 10 of the emergency call system, its content is evaluated and an acknowledgement message, the structure of which can be seen in FIG. 4a, is then transmitted via the satellite in a subsequent step S105. If, in contrast, it was not possible to receive an inquiry, the communication device will not receive an answer either and accordingly repeat steps S101 and S102 after a certain waiting period, i.e. attempt to transmit a new inquiry to the satellite.

According to the embodiment shown in FIG. 4a, the acknowledge message sent back in the case of a successful inquiry has a total length of 120 bits and is composed of five individual data blocks. A first block 42-1 represents an (e.g. 32-bit-long) preamble which is used by the receiver addressed for synchronizing its receiving characteristic with the transmitting characteristic of the satellite. In the second block 42-2, the identification number of the participant is repeated in order to ensure that of a number of terminals which have transmitted an inquiry to the satellite at an early time, a single participant can be addressed. The third block 42-3 is used for coding, with the aid of an 8-bit-long data packet, a reception frequency f_{E} on which the satellite wishes to receive the emergency call message at a later time. The subsequent block 42-4 codes a time interval t_{E} established for the reception of this message with the aid of 4 bits. The last block 42-5 is used for acknowledging the reception of the inquiry as part of a short response and possibly conveying further information about the type of aid made available.

The structure of this return message could again be selected to be different but the blocks for unambiguously identifying the communication device and for transmitting the specified reception frequency and reception time are required as part of the method according to the invention.

After this information has been received, the terminal determines in the subsequent step S106, taking into consideration the navigation information provided to it, a suitable transmission frequency fₛ₂ and a transmitting time tₛ₂ for transmitting the actual emergency message. Frequency and time are again determined in a suitable manner in order to ensure that the message arrives at the satellite with the previously specified reception frequency f_{E} and within the required period t_{E}.

In the next step S107, the text message is then transmitted in the manner previously determined, selecting a data format according to the representation in FIG. 3b in this case. Accordingly, this message 41 again consists of two blocks 41-1 and 41-2 for transmitting the identification number and for conveying navigation information via the receiver. A third block (for example with a length of 1600 bits) finally represents the actual message or the emergency call, respectively.

The initialization process previously carried out or the reservation of a certain receiving period, respectively, ensure that the message arrives at the satellite as the only one at the predetermined reception time, undisturbed by other information. This eliminates an overlap with other signals which is of particularly importance in order to avoid data collision during the relatively long transmission period. This ensures that the actual emergency message can be transmitted undisturbed to the satellite and can be evaluated reliably there.

In steps S108 and S109, finally, the message is forwarded to the ground station and a new acknowledgement is provided via the satellite. The data format shown in FIG. 4a is again used for the acknowledgement but the data blocks now remain empty with regard to frequency and reception time. If, in contrast, the transmission of the message has failed, this could possibly be indicated with the aid of the fifth data block 42-5 and the participant could be requested to retransmit the emergency message. In this case, a new reception frequency and a reception time would again be established and transmitted.

FIG. 5a shows the special procedure for transmitting an emergency message according to the method according to the invention again by means of a timing diagram. In particular, this representation also shows that the receiving characteristic of the satellite in time can be subdivided into two alternating time intervals T_{A} and T_{B}, wherein the first time interval T_{A} is used for receiving the inquiries from the various communication devices and is divided into further small time intervals Tₐ which are in each case provided for receiving an inquiry. The second part-section T_{E} is provided for receiving exactly one SMS message.

According to the representation, a participant A thus transmits an inquiry 50 at time tₛ₁, this time being selected in such a manner that this inquiry arrives at the satellite exactly within a predetermined time interval Tₐ of the period T_{A} for receiving inquiries. After this inquiry has been forwarded to the ground station, the return message is sent via the first acknowledgement message 51 with which the participant A is informed about the reception time t_{E} provided for him and the corresponding frequency. As can be seen from the diagram, this return message is sent independently of the transmission of a message 55, carried out at the same time, which was transmitted by a second participant B in such a manner that it arrives at the satellite within the earlier receiving period T_{E} for text messages.

On the basis of the information received as part of the first return message 51 and taking into consideration the navigation data, the participant A then determines the time tₛ₂ at which the transmission of the text message is started, in such a manner that it arrives at the satellite at the predetermined time t_{E}. After successful forwarding and evaluation at the ground station, the second return message 53 is then sent.

It is thus essential that the participants arrange their transmitting characteristic in such a manner that both the inquiries and the actual text messages arrive at the satellite in suitable manner and can be optimally received there. Naturally, this does not apply to the various return messages from the satellite to the participants since the satellite cannot match its transmitting behavior to every individual participant. In this case, too, however, the navigation information provided additionally to the participants and the other information about the transmission behavior of the satellite with time can be used for matching the reception behavior of the participant to the satellite. On the basis of this (auxiliary) information alone, synchronization or estimation of the phase position of the reply signal can thus be achieved already in order to ensure optimum data reception at the various participants. As a supplement to this, the preamble 42-1 of the return message 42 in FIG. 4a is also used. However, this preamble does not absolutely need to be a component of each individual return message by the satellite. It would also be easily conceivable to add the preamble to the return messages only at regular time intervals.

The previously explained procedure for optimized data reception by the communication devices is also illustrated again in FIG. 5b. It shows diagrammatically a first transmitter S1 which can be, for example, the transmitter of the satellite 30 for the message or information transmission. The data transmitted by this first transmitter E1 are to be received by the first receiving means E1 of the communication device 20, 21. In principle, the data could already be transmitted via this first data link L1, and the data could be evaluated at the receiving means E1, on the basis of the preamble since these preambles enable the first receiving means E1 to be synchronized to the first transmitter S1.

According to the special method, however, auxiliary information is provided to the communication device 20, 21 via a second data link L2, separately—and, for example, in a different frequency range—from the data transmitted via the first link L1. This auxiliary information is transmitted by a second transmitter S2 of the satellite—particularly the transmitter for transmitting navigation information—and received by second receiving means E2 of the communication device 20, 21. This auxiliary information allows conclusions about the transmitting characteristic of the first transmitter S1 since the latter orients its behavior in accordance with the timing diagram predetermined by the navigation unit of the satellite 30. By forwarding the auxiliary information received by the second receiving means E2 to the first second receiving means E1, these can orient their receiving characteristic to the transmitting characteristic of the first transmitter E1, which is now known to them.

For example, it can thus be provided that the first transmitter S1 transmits response signals to the various participants of the communication system at every full second, the time base for this being taken from the navigation system of the satellite 20. Since this information about the timing characteristic of the navigation system is also available to the first receiving means E1, these “know” at which times and which frequencies signals will arrive. As has already been mentioned above, it is possible to achieve almost perfect synchronization between the first transmitter S1 and the receiving means E1 in this manner and deviations occur in the range of nanoseconds, if at all. This clearly optimizes the reception of the data signals on the first link 1.

It should be noted that it is particularly advantageous if both the transmitters S1, S2 and the receiving means E1, E2 are in each case a component of a single device. In the embodiment of the emergency call system shown, this is the case anyway since the communication devices additionally have a navigation receiver. A completely separate transmission of the auxiliary information would also be conceivable, however.

Overall, the measures specified thus ensure that an error-free data transmission can take place in both directions between the communication device of the end users and the satellite. The responsible agents for this are, on the one hand, the matched transmitting characteristic of the participants in time and the matched receiving characteristic of the participants on the basis of the information with regard to the transmitting characteristic of the satellite or satellites which is additionally available, wherein these measures can also be used independently of the type of information to be transmitted.

The previous considerations have been restricted to the communication between a participant and a single satellite. In fact, however, an emergency call/warning system formed on the basis of the present invention will have a number of satellites in order to ensure global data transmission. In this case, however, the satellites must use different frequencies in order to avoid an overlap in the data traffic. The frequency band for the reverse uplink II_{U}, mentioned initially, must thus be subdivided into frequency bands which can be used individually in each case for the satellites. According to the representation in FIG. 6, however, it is not required that each satellite is given exactly one single frequency band. Due to the shading by the earth, there is the possibility that two satellites arranged in opposition to one another (for example satellites 30-3 and 30-7) use common frequency ranges. When 24 satellites are used, for example, the entire frequency band with a width of 1 MHz is thus to be subdivided into a total of 12 ranges having a width of in each case 83.3 kHz.

For each satellite, a corresponding frequency band is thus available which is advantageously subdivided again into 100 subranges (so called subcarriers) according to the representation in FIG. 7. Within each subcarrier, having a width of 833 Hz, information can then be transmitted from the end users to the satellite. If it is assumed that the periods T_{A} for the initialization (composed of 11 time slots Tₐ for receiving in each case one inquiry) and T_{E} for receiving the actual SMS message together take up about 10 s, this means that a single satellite is capable of receiving approximately 10 text messages per second. This is sufficient by far for processing the expected emergency calls in accordance with the calculation made above. The system according to the invention is thus in fact capable of providing the service of an emergency call system globally.

It must be noted that the subcarrier provided in each case for receiving a text message predetermines the reception frequency which is transmitted to the end user in the context of the first acknowledgement message. Since the satellite or the ground station selects this subcarrier in accordance with the manner in which the available frequencies are optimally used, the matching of the transmission frequency by the participants, described initially, is thus the prerequisite for reliable data transmission. During the inquiry, in contrast, the participants can arbitrarily select a frequency of a corresponding subcarrier since these frequencies are not permanently issued for the inquiries. In this case, selection takes place in accordance with the principle of randomness, if possible, in order to provide for a uniform utilization of the subcarriers and thus to avoid collisions, if possible.

The previous explanation referred to the procedure and the various measures for reliably transmitting the various information items in the context of an emergency call delivered individually by a participant. A second function of the emergency call/warning system according to the invention, shown in FIG. 1, also consists in warning participants of the system about impending hazards. For example, persons affected should be warned against impending earthquakes or flood waves. Bad weather warnings for affected regions would also be a conceivable application for such a warning system.

In comparison with the data transmission as part of an emergency call, the task is here not to individually address a participant but to warn all participants affected by an impending hazard at the same time if possible. Thus, as many terminals as possible must be addressed within the shortest possible period but the warning information should lastly only be forwarded to those users possibly affected by the impending event.

Accordingly, a first aspect of this warning function of the system 1 according to the invention consists in specifying, together with the transmission of the text message which informs about the impending event, also the geographic region for which the information is relevant. In accordance with the representation in FIG. 8, the local relevance for the message or the geographic region affected is preferably defined by a number of individual locations or positions which jointly delimit the region affected. According to the representation in FIG. 8, seven different points are accordingly selected which, in the case shown, enclose a region of lakes 60 which is affected by a storm warning which is the actual subject of the warning message.

Delimiting the affected region 60 depends on how many locations are available which are to enclose the region 60. Naturally, a larger number of locations leads to an increased volume of data which is why a compromise must be found in this case in order to define the actual region in a data packet which is compressed, if possible.

According to a particularly advantageous development, it is accordingly provided to define the region 60, on the one hand, by a reference position 61, the location of which is specified very accurately and, on the other hand, to specify the other points as relative positions 62-1 to 62-6, the position of which is specified relative to the reference position. In the example shown, it could be provided, for example, to specify the reference position 61 with the aid of a total of 50 bits, wherein 25 bits could then be used in each case for the length and width of the reference position 61 which lastly enables a position to be specified with an accuracy of 1.2 meters. The relative positions, in contrast, could be specified with an accuracy of 32 bits (16 bits for the length and 16 bits for the width) wherein in each case a step width of 91 meters is selected. The consequence is that, overall, a region having a length and width of 6000 km in each case can be defined which is sufficient for all conceivable scenarios.

It must be noted again that the various value ranges for specifying the individual positions could also be selected to be different in order to specify the region 60 affected. For example, it would also be conceivable to make the accuracy dependent on the maximum size of the region.

For the warning message, a data format can then be selected as is shown, for example, in FIG. 4b. The entire data packet 43 consists of four different blocks, wherein a first block (for example with a length of 1600 bits) is used as so-called coordination component or preamble which is used for enabling the receiving devices to be synchronized to the satellite signal. It is noteworthy that the preamble is very long in the embodiment shown; according to the later discussion, this is used for enabling the satellite signals also to be received in closed rooms or buildings.

The two further blocks 43-2 and 43-3 are used for specifying the local relevance of the message contained in the subsequent block 43-4, the so called information component, wherein block 43-2 is used for specifying the reference position 61 explained previously whereas block 43-3 specifies the relative positions 62-1 to 62-6.

As already mentioned, a special feature of the data format for the warning message, shown in FIG. 4b, consists in that a very long preamble 43-1 is selected. The reason for this is that, in the context of the warning function of the communication system 1 according to the invention, the warning message is to be transmitted not only to receivers located in the open air but, in particular, devices are also to be addressed which are located within closed buildings and are used as stationary devices. However, as can be seen in the representation in FIG. 1, direct reception of the satellite signal is not possible for such devices 42, as a rule. Instead, only signal components are received which are reflected from objects located in the environment, for example trees 24. The signal finally arriving at the device 22 is correspondingly distinctly weakened.

By way of the particularly or superproportionally long preamble of the warning message, care is now taken to ensure first that the receiver can be synchronized to the satellite signal even with a very weak signal arriving at the receiver 22. This measure alone would not yet be sufficient for a suitable reception of the actual warning information since the information component of the signal is in the end too noisy to be able to evaluate and utilize the information with certainty. In the context of an advantageous development of the system according to the invention, a special method for data transmission is accordingly used which is shown diagrammatically in FIG. 9.

The basic idea of this special transmission method, which could also be utilized independently of the developments of the system described above, consists in that the warning messages are transmitted more frequently and are added together in the correct phase by the receivers until the aggregate signal produced during this process enables the information to be evaluated without errors. For example, according to the example shown, a particular warning information MSG A is sent five times according to the example shown, the corresponding information components 70-2 to 73-2 and 75-2 being added together by the receiving means of the communication device to form the aggregate signal 76. The important factor is here that the information components are added together in the correct phase for the purpose of which the respective previous transmission of the preambles or the coordination components 70-1 to 73-1 and 75-1, respectively, is used. In-phase adding of the information components is only possible by means of the previous accurate synchronization of the receiver to the satellite signal by using the preambles, so that the desired amplification of the aggregate signal 76 is achieved.

A further special feature of the method also consists in that it is not absolutely necessary that the corresponding message is repeated periodically. Instead, another message MSG B which contains information relating to a different event and may be intended for participants of the communication system 1 in another geographic region can also be transmitted in the meantime. To ensure that the information component 74-2 is not accidentally added to the information components of the first message MSG A, it must thus be ensured that the receiver receives knowledge about which message is currently being transmitted. For this purpose, the coordination component or the preamble, respectively, preceding the information component with the message can again be used. In this context, the preamble additionally contains information via which the message can be identified. Although this information does not provide information about the content of the message, it allows it to be identified so that it is ensured that only those information components which are associated with a common message are added together. Apart from the phase estimation required for synchronizing the receivers, the preamble lastly also fulfills the task of identifying the messages in order to enable an unambiguous aggregate signal to be formed in the sense of the method according to the invention.

The in-phase amplification of the information components achieved in this manner ultimately means that the aggregate signal 76 formed can be unambiguously evaluated for processing the message further. This also ensures that even receivers located inside buildings can utilize the satellite signal after a multiple retransmission of the message. The desired effect end for this means is that an item of warning information can be transmitted simultaneously to as many persons as possible or precisely the persons affected.

It must be noted that the method described above is not restricted to the reception of satellite signals but, in principle, can also be used when text information is to be transmitted by means of a signal arriving relatively weakly at a receiver. By in-phase addition of the information components transmitted several times, a suitable amplification of the signal can then be achieved until it can be evaluated, even with other types of transmission methods.

Thus, a multiplicity of affected participants can thus be supplied with warning messages by means of the second function of the emergency call/warning system according to the invention. Adding information with regard to the local relevance of the warning information also ensures that the participants can also find out whether they are affected by this message or not. According to a particularly preferred embodiment, it is even provided that evaluating means provided in the receiving devices independently evaluate the information with regard to the local relevance and check by means of supplementary information whether the message happens to be relevant to the receiver due to its current position, or not. It is only after this relevance has been checked, that the device itself decides whether it processes and, for example, reproduces the messages visually or acoustically by means of suitable processing and reproduction means, respectively. Thus, the problem that the user of the device receives a multiplicity of warning information items and then must determine independently every time whether the message of significance to him or not does not exist.

This advantageous prefiltering or automatic evaluation of the local relevance of messages can take place, in particular, by using navigation information which is provided to the receiver, for example again via the satellite. However, it would also be conceivable to determine the current position of the receiver by other means without being dependent on the reception of additional navigation signals. If, for example, a mobile radio telephone is used as receiving device, the position of the receiver can also be determined roughly via the cell ID of the telephone network. A manual input of the current position by the user and storing of this information in a corresponding memory of the receiving device would also be conceivable.

It must be noted that the idea of prefiltering or of automatic evaluation of the local relevance of messages, described above, could also be used independently and is not restricted to the transmission by means of satellites in this case. A corresponding coding would also be conceivable in the case of message transmission by means of terrestrial transmitters for radio or television operation. Furthermore, the method according to the invention could also be used in the message transmission by telephone or mobile radio. In principle, this would have the advantage that only those persons receive the message to whom it is actually relevant.

Apart from the specification of the local relevance of the warning information, there could be further detailing with regard to the user of the system or the arrangement of the receiving device in particular facilities. Thus, the information about a storm warning, for example, is certainly relevant to a receiver installed on a ship whereas, in contrast, it is of less interest to a user located within a closed building. By inserting an additional data block, for example, various user categories could be specified wherein the device then automatically determines additionally also on the basis of this information whether the information should be reproduced or not. In this case, in turn, a manual input by the user could specify what messages are of interest or not. This provides for a very comfortable capability for an individual warning against hazards relevant to the user of a device.

The above explanations of the various functions of the system according to the invention show that the terminals via which communication takes place with the satellite or the central station of the emergency call/warning system, respectively, can be arranged in the most different ways and can also provide different functionalities. In this context, the devices can be subdivided into various categories with regard to their possible uses.

In the first place, there are devices which enable both text messages to be transmitted for delivering an emergency call and global warning messages to be received. These devices additionally usually also have a navigation receiver in order to be able to make use of the navigation information needed in the context of the various transmission methods. These devices of the first category can be formed, for example, by portable communication devices. However, it would also be conceivable to install such devices in vehicles such as aircraft, ships or motor vehicles. When such devices are arranged in vehicles, in particular, it could also be provided additionally that the delivery of an emergency call is initiated automatically in the case of an accident or the like. Naturally, it is advantageous to arrange the communication device at a place which is affected as little as possible by accidents in this case. When it is arranged in a vehicle, for example, installation within the passenger cabin—particularly on the dashboard—would be appropriate since the greatest safety against unwanted damage exists in this area.

A second category of devices is formed by those which are again arranged in moving objects such as e.g. vehicles, or are constructed as portable communication devices. In contrast to the devices of the category described before, which also enable text messages to be transmitted and accordingly must take into consideration navigation information with regard to the participant and the satellite in order to achieve error-free data transmission, the devices of the second category are exclusively provided for receiving global warning messages. In this case, the use of a navigation receiver is not absolutely required since, because of the measures with regard to the transmission of warning messages described before, the supplementary use of navigation information is not absolutely required. Nevertheless, the navigation receiver would also entail additional advantages in these cases. On the one hand, the information received via it can be used as auxiliary information for matching the receiving characteristic of the device optimally to the satellite signal. In addition, the navigation receiver also offers the possibility of automatically checking the relevance of the warning information with regard to a local restriction. However, this second possibility would also exist—as already described—due to the use of other types of information such as, e.g. the determination of position via the cell identification of a mobile radio network or by means of the previous manual input by a user of the device.

A third category of possible terminals, finally, consists of quasi-stationary devices which, in particular, are arranged within closed buildings. Such devices can be formed, for example, by electric devices such as television sets or radios. They are exclusively constructed for receiving the global warning information of the system, wherein, because of the measures described before, reception of the information is possible even though the devices are arranged within closed buildings. The use of an additional navigation receiver is not appropriate in this case. To be able to perform an automatic presorting of warning information with regard to the local relevance, it is advantageously provided in such devices that corresponding information is carried out by a user during the installation of the device.

Seen overall, the present invention and the various measures described, respectively, provide a satellite-based communication system which enables text information to be transmitted reliably in combination with location information. This now provides the possibility of forming a global emergency call/warning system which enables data to be exchanged with the required reliability.

1-94. (canceled)

95. A communication system (1) preferably to be used in a global emergency call/warning system, with at least one communication device (20, 21, 22) and with a central facility (10) connected to the communication device (20, 21, 22) for exchanging text information,
wherein the connection between the communication device (20, 21, 22) and the central facility (10) is made via at least one satellite (30) and
wherein data transmitted by the communication device (20, 21, 22) contain additional information about the current position of the communication device (20, 21, 22) or data transmitted by the central facility (10) contain additional information about the local relevance of the text information.

96. A communication system as claimed in claim 95, wherein data transmitted by the communication device (20, 21, 22) to the central facility (10) also contain information with regard to a movement of the communication device (20, 21, 22).

97. A communication system as claimed in claim 95, wherein data transmitted by the central facility (10) to the communication device (20, 21, 22) also contain additional information which provides information about a user-specific relevance of the text information transmitted.

98. A communication system as claimed in claim 95, wherein the communication device (20, 21, 22) first checks, by evaluating the additional information about the local relevance and/or the additional information with regard to the user-specific relevance of the text information, whether the text information is relevant to the respective communication device (20, 21, 22) and processes or reproduces, respectively, the text information in dependence on this check.

99. A communication system as claimed in claim 95, wherein the system has a number of satellites (30) which enable data to be exchanged in different frequency bands, wherein the communication device (20, 21, 22) transmits data at the frequency of the satellite (30) which guarantees the best possible transmission on the basis of its current position.

100. A communication system as claimed in claim 95, wherein the communication device (20, 21, 22) is portable.

101. A communication system as claimed in claim 95, wherein the communication device (20, 21, 22) is integrated in a vehicle.

102. A communication system as claimed in claim 95, wherein the communication device (20, 21, 22) is arranged inside a building (23).

103. A communication system as claimed in claim 102, wherein the communication device (20, 21, 22) is a component of an electric device, particularly a television set or a radio.

104. A communication system as claimed in claim 95, wherein the data transmitted via the satellite (30) contain an information component (70-2 to 75-2) containing the text information, and a coordination component (70-1 to 75-1) which is used by the communication device (20, 21, 22) for synchronizing to the satellite (30),
wherein the data containing the text information are transmitted at least twice by the satellite (30) and the communication device (20, 21, 22) adds the information components (70-2 to 75-2), received during the multiple transmissions, in the correct phase and determines the text information from the aggregate signal (76) formed during this process.

105. A communication system as claimed in claim 95, wherein, for transmitting text information from the communication device (20, 21, 22) to the satellite (30), data with regard to a predetermined reception time (t_{E}) for the information and/or a predetermined reception frequency (f_{E}) are first transmitted to the communication device (20, 21, 22) as part of an initialization procedure,
wherein the communication device (20, 21, 22) determines a suitable time (tₛ₂) for transmitting the information and/or a suitable transmission frequency (fₛ₂) on the basis of supplementary information with regard to the positions and/or movements of the communication device (20, 21, 22) and of the satellite (30).

106. A communication system as claimed in claim 95, wherein the communication device (20, 21, 22) matches its behavior for receiving the data, transmitted by the satellite (30), on the basis of supplementary information which is transmitted to the communication device (20, 21, 22) separately from the satellite signals.

107. A communication system as claimed in claim 106, wherein the supplementary information is information with regard to the positions and/or movements of the communication device (20, 21, 22) and of the satellite (30).

108. A method for exchanging text information between a communication device (20, 21, 22) and a central facility (10), wherein the connection between the communication device (20, 21, 22) and the central facility (10) is made via at least one satellite (30), and
wherein data transmitted by the communication device (20, 21, 22) contain additional information about the current position of the communication device (20, 21, 22) or data transmitted by the central facility (10) contain additional information about the local relevance of the text information.

109. A method as claimed in claim 108, wherein data transmitted by the communication device (20, 21, 22) to the central facility (10) also contain information with regard to a movement of the communication device (20, 21, 22).

110. A method as claimed in claim 108, wherein data transmitted by the central facility (10) to the communication device (20, 21, 22) also contain additional information which provides information about a user-specific relevance of the text information transmitted.

111. A method as claimed in claim 108, wherein the communication device (20, 21, 22) first checks, by evaluating the additional information about the local relevance and/or the additional information with regard to the user-specific relevance of the text information, whether the text information is relevant to the respective communication device (20, 21, 22) and processes or reproduces, respectively, the text information in dependence on this check.

112. A method as claimed in claim 108, wherein the system has a number of satellites (30) which enable data to be exchanged in different frequency bands, wherein the communication device (20, 21, 22) transmits data at the frequency of the satellite (30) which guarantees the best possible transmission on the basis of its current position.

113. A method as claimed in claim 108, wherein the communication device (20, 21, 22) is portable.

114. A method as claimed in claim 108, wherein the data transmitted via the satellite (30) contain an information component (70-2 to 75-2) containing the text information, and a coordination component (70-1 to 75-1) which is used by the communication device (20, 21, 22) for synchronizing to the satellite (30),
wherein the data containing the text information are transmitted at least twice by the satellite (30) and the communication device (20, 21, 22) adds the information components (70-2 to 75-2), received during the multiple transmissions, in the correct phase and determines the text information from the aggregate signal (76) formed during this process.

115. A method as claimed in claim 108, wherein for transmitting text information from the communication device (20, 21, 22) to the satellite (30), data with regard to a predetermined reception time (t_{E}) for the information and/or a predetermined reception frequency (f_{E}) are first transmitted to the communication device (20, 21, 22) as part of an initialization procedure,
wherein the communication device (20, 21, 22) determines a suitable time (tₛ₂) for transmitting the information and/or a suitable transmission frequency (fₛ₂) on the basis of supplementary information with regard to the positions and/or movements of the communication device (20, 21, 22) and of the satellite (30).

116. A method as claimed in claim 108, wherein the communication device (20, 21, 22) matches its behavior for receiving the data transmitted by the satellite (30) on the basis of supplementary information which is transmitted to the communication device (20, 21, 22) separately from the satellite signals.

117. A method as claimed in claim 116, wherein the supplementary information is information with regard to the positions and/or movements of the communication device (20, 21, 22) and of the satellite (30).

118. An information system (1) for transmitting messages from a central transmitting facility (10) to a multiplicity of communication devices (20, 21, 22), wherein data transmitted by the central transmitting facility (10) contain, apart from the messages, additional information which provides information about a local and/or user-specific relevance of the messages, and
wherein each communication device (20, 21, 22), by evaluating the additional information, first checks whether the messages are relevant to the respective communication device (20, 21, 22) and processes or reproduces, respectively, the messages in dependence on this check.

119. An information system as claimed in claim 118, wherein the additional information defines a geographic region (60) to which the messages are relevant.

120. An information system as claimed in claim 119, wherein the geographic region (60) is defined by a number of locations which enclose the region.

121. An information system as claimed in claim 120, wherein the number of locations are specified by a reference position (61) and a number of relative positions (62-1 to 62-6).

122. An information system as claimed in claim 121, wherein the reference position (61) and the relative positions (62-1 to 62-6) are specified with different accuracy.

123. An information system as claimed in claim 122, wherein the accuracy of the specification of the reference position (61) and of the relative positions (62-1 to 62-6) is dependent on the size of the region to be defined.

124. An information system as claimed in claim 122, wherein the reference position (61) is specified with a higher accuracy than the relative positions (62-1 to 62-6).

125. An information system as claimed in claim 119, wherein the local relevance of the received messages is checked on the basis of information with regard to the current location of the communication device (20, 21, 22).

126. An information system as claimed in claim 125, wherein the information with regard to the current location of the communication device (20, 21, 22) is obtained by means of a navigation receiver allocated or assigned to the communication device (20, 21, 22).

127. An information system as claimed in claim 125, wherein the information with regard to the current location of the communication device (20, 21, 22) is obtained via the cell identification number of a mobile radio network.

128. An information system as claimed in claim 125, wherein the information with regard to the current location of the communication device (20, 21, 22) is input manually by a user of the device.

129. A communication device (20, 21, 22) for use in an information system (1), having
receiving means for receiving data which contain messages and additional information which provides information about a local and/or user specific relevance of the messages,
evaluating means for checking by means of the additional information whether the messages are relevant to the communication device, and
processing and reproducing means for processing and reproducing, respectively, the messages in dependence on the result of the check by the evaluating means.

130. A communication device as claimed in claim 129, wherein it has further receiving means for determining the current position of the communication device (20, 21, 22).

131. A communication device as claimed in claim 130, wherein the further receiving means are formed by a navigation receiver allocated or assigned to the communication device (20, 21, 22).

132. A communication device as claimed in claim 129, wherein it has a memory for storing information with regard to the use of the communication device (20, 21, 22), this information being taken into consideration by the evaluating means.

133. A method for transmitting messages to a multiplicity of communication devices (20, 21, 22), wherein transmitted data contain, apart from the messages, additional information which provides information about a local and/or user-specific relevance of the messages, and
wherein, by evaluating the additional information, a check is first made whether the messages are relevant to the respective receiver (20, 21, 22) and the messages are processed or reproduced, respectively, in dependence on this check.

134. A method as claimed in claim 133, wherein the additional information defines a geographic region (60) to which the messages are relevant.

135. A method as claimed in claim 134, wherein the geographic region (60) is defined by a number of locations which enclose the region.

136. A method as claimed in claim 135, wherein the number of locations are specified by a reference position (61) and a number of relative positions (62-1 to 62-6).

137. A method as claimed in claim 136, wherein the reference position (61) and the relative positions (62-1 to 62-6) are specified with different accuracy.

138. A method as claimed in claim 137, wherein the accuracy of the specification of the reference position (61) and of the relative positions (62-1 to 62-6) is dependent on the size of the region to be defined.

139. A method as claimed in claim 138, wherein the reference position (61) is specified with a higher accuracy than the relative positions (62-1 to 62-6).

140. A method as claimed in claim 134, wherein the local relevance of the received messages is checked on the basis of information with regard to the current location of the receiver (20, 21, 22).

141. A method as claimed in claim 140, wherein the current location of the receiver (20, 21, 22) is determined via the cell identification number of a mobile radio network.

142. A communication system (1) comprising a communication device (20, 21, 22) and a central facility, formed by a satellite (30), for receiving information to be transmitted by the communication device (20, 21, 22), wherein data with regard to a predetermined reception time (t_{E}) for the information and/or a predetermined reception frequency (f_{E}) are transmitted to the communication device (20, 21, 22) as part of an initialization procedure, and
wherein the communication device (20, 21, 22) determines a suitable time (tₛ₂) for transmitting the information and/or a suitable transmission frequency (fₛ₂) on the basis of supplementary information with regard to the positions and/or movements of the communication device (20, 21, 22) and of the satellite (30).

143. A communication system as claimed in claim 142, wherein the communication device (20, 21, 22) transmits a first inquiry (40) to the satellite (30) as part of the initialization procedure and the satellite (30), in reply to this inquiry (40), transmits data with regard to the reception time (t_{E}) assigned to the communication device (20, 21, 22) for the information to be transmitted and/or the predetermined reception frequency (f_{E}).

144. A communication system as claimed in claim 143, wherein the communication device (20, 21, 22) already takes into consideration the information with regard to the positions and/or movements of the communication device (20, 21, 22) and of the satellite (30) in the transmission of the inquiry (40).

145. A communication system as claimed in claim 144, wherein the communication device (20, 21, 22) selects a time (tₛ₁) for transmitting the inquiry (40), in such a manner that the inquiry (40) arrives at the satellite (30) within a predetermined time interval (Tₐ).

146. A communication system as claimed in claim 143, wherein the system has a number of satellites (30) which enable data to be exchanged in different frequency bands, wherein the communication device (20, 21, 22) transmits the inquiry to the satellite (30) which guarantees the best possible transmission due to its current position.

147. A communication system as claimed in claim 142, wherein the communication device (20, 21, 22) matches its behavior for receiving the signals transmitted by the satellite (30) on the basis of supplementary information which is transmitted to the communication device (20, 21, 22) separately from the satellite signals.

148. A communication system as claimed in claim 147, wherein the supplementary information is information with regard to the positions and/or movements of the communication device (20, 21, 22) and of the satellite (30).

149. A communication device (20, 21, 22) comprising transmitting means for transmitting information to a central facility formed by a satellite (30), wherein the transmitting means are constructed for determining a suitable time (tₛ₂) for transmitting the information and/or a suitable transmission frequency (fₛ₂) in dependence on previously established data with regard to a predetermined reception time (t_{E}) and/or a predetermined reception frequency (f_{E}) and on the basis of supplementary information with regard to the positions and/or movements of the communication device (20, 21, 22) of the satellite (30).

150. A communication device as claimed in claim 149, wherein it has a navigation receiver wherein the data received via this navigation receiver are taken into consideration by the transmitting means as supplementary information during the determination of the suitable time (tₛ₂) for transmitting the information and/or the transmission frequency (fₛ₂).

151. A communication device as claimed in claim 149, wherein it is a portable device.

152. A communication device as claimed in claim 149, wherein it is provided for arrangement in a vehicle.

153. A method for transmitting information from a communication device (20, 21, 22) to a central receiving facility formed by a satellite (30), wherein a predetermined reception time (t_{E}) for the information and/or a predetermined reception frequency (f_{E}) are established as part of an initialization procedure, and
wherein a suitable time (tₛ₂) for transmitting the information and/or a suitable transmission frequency (fₛ₂) are determined on the basis of supplementary information with regard to the positions and/or movements of the communication device (20, 21, 22) and of the satellite (30).

154. A method as claimed in claim 153, wherein a first inquiry (40) is transmitted to the satellite (30) as part of the initialization procedure and the satellite (30), in response to this inquiry (40), transmits data with regard to the assigned reception time (t_{E}) for the information to be transmitted and/or the predetermined reception frequency (f_{E}).

155. A method as claimed in claim 154, wherein the information with regard to the positions and/or movements of the communication device (20, 21, 22) and of the satellite (30) are already taken into consideration during the transmission of the inquiry (40).

156. A method as claimed in claim 155, wherein, for transmitting the inquiry (40), a time (tₛ₁) is selected in such a manner that the inquiry (40) arrives at the satellite (30) within a predetermined time interval (Tₐ).

157. A system (1) preferably to be used in a global warning system for transmitting messages from a central transmitting facility via a satellite (30) to at least one communication device (20, 21, 22), wherein data transmitted by the satellite (30) contain an information component (70-2 to 75-2) containing the messages and a coordination component (70-1 to 75-1) which is used by the communication device (20, 21, 22) for synchronizing to the satellite (30), wherein the data containing the messages are transmitted at least twice by the satellite (30), and the communication device (20, 21, 22) adds the information components (70-2 to 75-2) received during the multiple transmissions in the correct phase and determines messages from the aggregate signal (76) formed during this process.

158. A system as claimed in claim 157, wherein the coordination component (70-1 to 75-1) in each case precedes the information component (70-2 to 75-2).

159. A system as claimed in claim 157, wherein the coordination component (70-1 to 75-1) is used for phase estimation of the information component (70-2 to 75-2).

160. A system as claimed in claim 157, wherein different messages are transmitted by the transmitting facility (10), wherein the coordination component (70-1 to 75-1) additionally also identifies the respective associated information component (70-2 to 75-2),
and the communication device (20, 21, 22) in each case adds the information components (70-2 to 75-2) of the corresponding messages.

161. A system as claimed in claim 157, wherein the data transmitted by the transmitting facility (10) contain additional information which provides information about a local and/or user-specific relevance of the messages.

162. A system as claimed in claim 161, wherein the communication device (20, 21, 22) first checks, by evaluating the additional information about the local relevance and/or the additional information with regard to the user-specific relevance of the text information, whether the text information is relevant to the respective communication device (20, 21, 22) and processes or reproduces, respectively, the text information in dependence on this check.

163. A system as claimed in claim 157, wherein the communication device (20, 21, 22) is arranged inside a building (23).

164. A system as claimed in claim 163, wherein the communication device (20, 21, 22) is a component of an electric device, particularly a television set or a radio.

165. A system (1) preferably to be used in a global warning system for transmitting messages from a central transmitting facility to at least one communication device (20, 21,77 22), wherein data transmitted by the central transmitting facility contain an information component (70-2 to 75-2) containing the messages, and a coordination component (70-1 to 75-1) which is used by the communication device (20, 21, 22) for synchronizing to the transmitting facility, wherein the coordination component (70-1 to 75-1) is selected to be superproportionally long,
the data containing the messages are transmitted at least twice by the transmitting facility and the communication device (20, 21, 22) adds the information components (70-2 to 75-2) received during the multiple transmissions in the correct phase and determines the messages from the aggregate signal (76) formed during this process.

166. A communication device (20, 21, 22) preferably to be used in a global warning system (1),
comprising receiving means for receiving data which contain an information component (70-2 to 75-2) containing messages, and a coordination component (70-1 to 75-1), wherein the coordination component (70-1 to 75-1) of the data is used by the receiving means of the communication device (20, 21, 22) for synchronizing to a transmitting facility transmitting the data, and
wherein the receiving means are also constructed for adding the information components (70-2 to 75-2) received during a multiple transmission of the data in the correct phase and determining the messages from the aggregate signal (76) formed during this process.

167. A communication device as claimed in claim 166, wherein the receiving means use the coordination component (70-1 to 75-1) for phase estimation of the associated information component (70-2 to 75-2).

168. A communication device as claimed in claim 166, wherein different messages are transmitted, wherein the coordination component (70-1 to 75-1) additionally also identifies the respective associated information component (70-2 to 75-2), and the receiving means in each case add the information components (70-2 to 75-2) of the corresponding messages.

169. A communication device as claimed in claim 166, wherein the transmitted data contain additional information which provides information about a local and/or user-specific relevance of the messages, wherein the communication device (20, 21, 22) additionally has evaluating means for checking by means of the additional information whether the messages are relevant to the communication device (20, 21, 22), and
processing and reproducing means for processing and reproducing, respectively, the messages in dependence on the result of the check by the evaluating means.

170. A communication device as claimed in claim 166, wherein it is provided to be arranged inside a building (23).

171. A communication device as claimed in claim 170, wherein it is a component of an electric device, particularly a television set (22) of a radio.

172. A method for transmitting messages from a central transmitting facility via a satellite (30) to at least one communication device (20, 21, 22), wherein data transmitted by the satellite (30) contain an information component (70-2 to 75-2) containing the messages, and a coordination component (70-1 to 75-1) which is used by the communication device (20, 21, 22) for synchronizing to the satellite (30), wherein the data containing the messages are transmitted at least twice and the information components (70-2 to 75-2) received during the multiple transmissions are added in the correct phase and messages are determined from the aggregate signal (76) formed during this process.

173. A method as claimed in claim 172, wherein the coordination component (70-1 to 75-1) in each case precedes the information component (70-2 to 75-2).

174. A method as claimed in claim 172, wherein the coordination component (70-1 to 75-1) is used for phase estimation of the information component (70-2 to 75-2).

175. A method as claimed in claim 172, wherein different messages are transmitted, wherein the coordination component (70-1 to 75-1) additionally also identifies the respective information component (70-2 to 75-2), and the information components (70-2 to 75-2) of the corresponding messages are in each case added.

176. A method as claimed in claim 172, wherein the transmitted data contain additional information which provides information about a local and/or user-specific relevance of the messages.

177. A method as claimed in claim 176, wherein, by evaluating the additional information with regard to the local and/or user-specific relevance of the messages, a check is first made whether the messages are relevant to the respective communication device (20, 21, 22) and the messages are processed and reproduced, respectively, in dependence on this check.

178. A communication system (1) comprising a transmitting facility (30) for transmitting data signals and a communication device (20, 21, 22) for receiving these data signals, wherein the communication device (20, 21, 22) matches its behavior for receiving the data signals on the basis of supplementary information which is transmitted to the communication device (20, 21, 22) separately from the data signals.

179. A communication system as claimed in claim 178, wherein the supplementary information is information with regard to the positions and/or movements of the communication device (20, 21, 22) and of the transmitting facility (30).

180. A communication system as claimed in claim 178, wherein the supplementary information is transmitted in a different frequency band from the data to be received.

181. A communication system as claimed in claim 178, wherein the transmitting facility (30) transmits both the data and the supplementary information.

182. A communication system as claimed in claim 181, wherein the transmitting facility is a satellite (30).

183. A communication device (20, 21, 22) for use in a communication system, wherein the communication device (20, 21, 22) has receiving means (E1) for receiving data which are transmitted by a transmitting facility (30), wherein the communication device (20, 21, 22) also has means (E2) for receiving supplementary information which contains information with regard to certain characteristics of the data to be received, wherein the receiving means (E1) match their behavior for receiving the data on the basis of the supplementary information.

184. A communication device as claimed in claim 183, wherein the supplementary information is information with regard to the positions and/or movements of the communication device (20, 21, 22) and of the transmitting facility (30).

185. A communication device as claimed in claim 184, wherein the means (E2) for receiving the supplementary information are formed by navigation receiver.

186. A method for transmitting data from a transmitting facility (30) to a communication device (20, 21, 22), wherein the communication device (20, 21, 22) matches its behavior for receiving the data on the basis of supplementary information which is transmitted to the communication device (20, 21, 22) separately from the data.

187. A method as claimed in claim 186, wherein the supplementary information is information with regard to the positions and/or movements of the communication device (20, 21, 22) and of the transmitting facility (30).

188. A method as claimed in claim 186, wherein the supplementary information is transmitted in a different frequency band from the data to be received.
